(19) United States
(12) Patent Application Publication
(10) Pub. No.: US 2023/0202401 A1
(43) Pub. Date: Jun. 29, 2023

(54) SEAT ASSEMBLY

(71) Applicant: Lear Corporation, Southfield, MI (US)

(72) Inventors: Mark Weaver, Auburn Hills, MI (US); Sumanth Muthyala, Ann Arbor, MI (US); Brandon Landry, Clarkston, MI (US); Paul Severinski, Brownstown, MI (US); Michael R. Powell, Waterford, MI (US)

(21) Appl. No.: 17/563,140

(22) Filed: Dec. 28, 2021

(51) Int. Cl. B60R 7/00; B60R 7/04

(52) U.S. Cl. CPC B60R 7/005; B60R 7/043

(57) ABSTRACT

A seat assembly may include a seatback, a seat base, and/or a retractable cover assembly connected to the seat base. The retractable cover assembly may include a retractable cover that is selectively connectable to the seatback. The retractable cover assembly may include a housing mounted to an underside of the seat base. The seat base may be configured to rotate relative to the seatback between a seating position and a storage position. The retractable cover may be selectively connectable to the seatback at least when the seat base is in the seating position. The retractable cover may be selectively connectable to a second seatback of a second seat at least when the seat base is in the storage position.

### TECHNICAL FIELD

The present disclosure generally relates to seat assemblies, including seat assemblies that may include a retractable cover and/or may, in some examples, be used in connection with vehicles.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some seat assembly designs do not provide sufficient functionality, involve complex assembly or use processes, and/or may not restrict movement of cargo.

There is a desire for solutions/options that minimize or eliminate one or more challenges or shortcomings of seat assemblies. The foregoing discussion is intended only to illustrate examples of the present field and is not a disavowal of scope.

### SUMMARY

In embodiments, a seat assembly may include a seatback, a seat base, and/or a retractable cover assembly connected to the seat base. The retractable cover assembly may include a retractable cover that is selectively connectable to the seatback. The retractable cover assembly may include a housing mounted to an underside of the seat base. The seat base may be configured to rotate relative to the seatback between a seating position and a storage position. The retractable cover may be selectively connectable to the seatback at least when the seat base is in the seating position. The retractable cover may be selectively connectable to a second seatback of a second seat at least when the seat base is in the storage position.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of a seat assembly according to teachings of the present disclosure.

FIG. 2 is a bottom view generally illustrating portions of an embodiment of a seat assembly according to teachings of the present disclosure.

FIG. 3 is a perspective view generally illustrating portions of an embodiment of a seat assembly according to teachings of the present disclosure.

FIGS. 4 and 5 are perspective views generally illustrating an embodiment of a retractable cover assembly according to teachings of the present disclosure.

FIG. 6 is a bottom view generally illustrating an embodiment of a retractable cover assembly according to teachings of the present disclosure.

FIG. 7 is a perspective view generally illustrating portions of an embodiment of a retractable cover assembly according to teachings of the present disclosure.

FIG. 8 is a perspective view generally illustrating portions of an embodiment of a retractable cover assembly according to teachings of the present disclosure.

FIG. 9 is a perspective view generally illustrating portions of an embodiment of a retractable cover according to teachings of the present disclosure.

FIG. 10 is a perspective view generally illustrating an embodiment of a handle of a retractable cover according to teachings of the present disclosure.

FIG. 11 is a partial perspective view generally illustrating portions of an embodiment of a retractable cover assembly according to teachings of the present disclosure.

FIG. 12 is an exploded perspective view generally illustrating portions of an embodiment of a retractable cover assembly according to teachings of the present disclosure.

FIG. 13 is a partial perspective view generally illustrating portions of an embodiment of a seat assembly according to teachings of the present disclosure.

FIGS. 14-17 are perspective views generally illustrating embodiments of a seat assembly according to teachings of the present disclosure.

FIGS. 18 and 19 are side views generally illustrating an embodiment of a seat assembly according to teachings of the present disclosure.

FIG. 20 is a perspective view illustrating an embodiment of a seat assembly according to teachings of the present disclosure.

FIG. 21 is a partial perspective view generally illustrating portions of an embodiment of a seat assembly according to teachings of the present disclosure.

FIGS. 22 and 23 are perspective views generally illustrating embodiments of a seat assembly according to teachings of the present disclosure.

FIG. 24 is a partial perspective view generally illustrating portions of an embodiment of a seat assembly according to teachings of the present disclosure.

FIGS. 25 and 26 are perspective views generally illustrating portions of embodiments of a seat assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

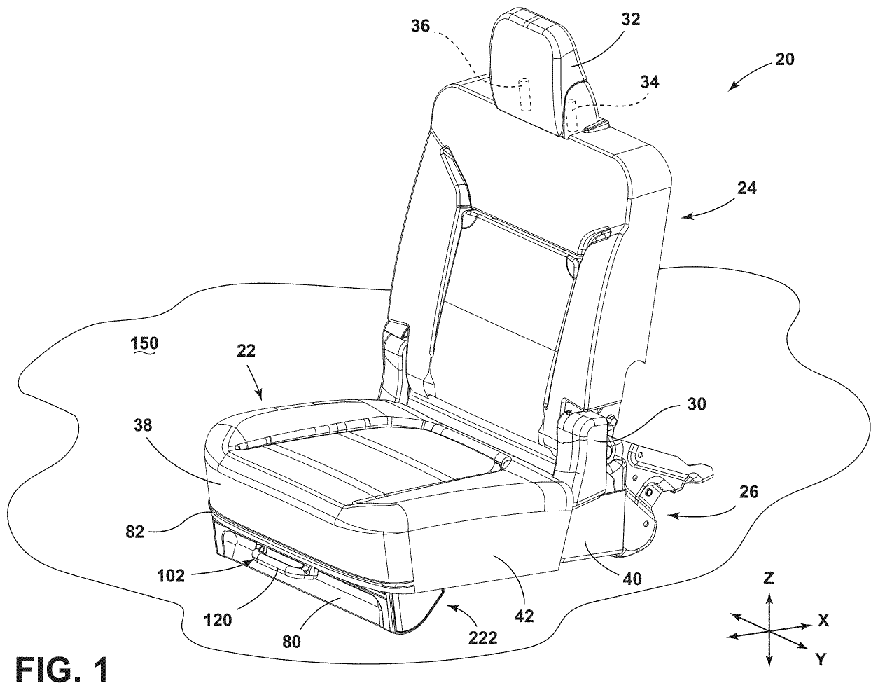

In embodiments, such as generally illustrated in FIG. 1, a seat assembly 20 may include a seat base 22, a seatback 24, a seat frame 26, and/or a retractable cover assembly 28. The seat base 22, the seatback 24, and/or the seat frame 26 may form a first seat 20A. The seat base 22 may be rotatably connected to the seat frame 26 such that the seat base 22 may rotate relative to the seatback 24 and/or the seat frame 26. For example and without limitation, a seat base 22 may rotate between a seat position (or positions) and a storage position, in which the seat base 22 may be substantially vertical and/or parallel with the seatback 24. The seatback 24 may be rotatably connected to the seat frame 26 (e.g., via a recliner 30) such that the seatback 24 may rotate relative to the seat base 22 and/or the seat frame 26. A seatback 24 may include a headrest 32 that include one or more posts 34, 36. The headrest 32 may be adjustably connected to the seatback 24 via the one or more posts 34, 36. The one or more posts 34, 36 may include metal and/or may extend substantially vertically and/or parallel to the seatback 24. The one or more posts 34, 36 may extend into/from a top surface of the seatback 24.

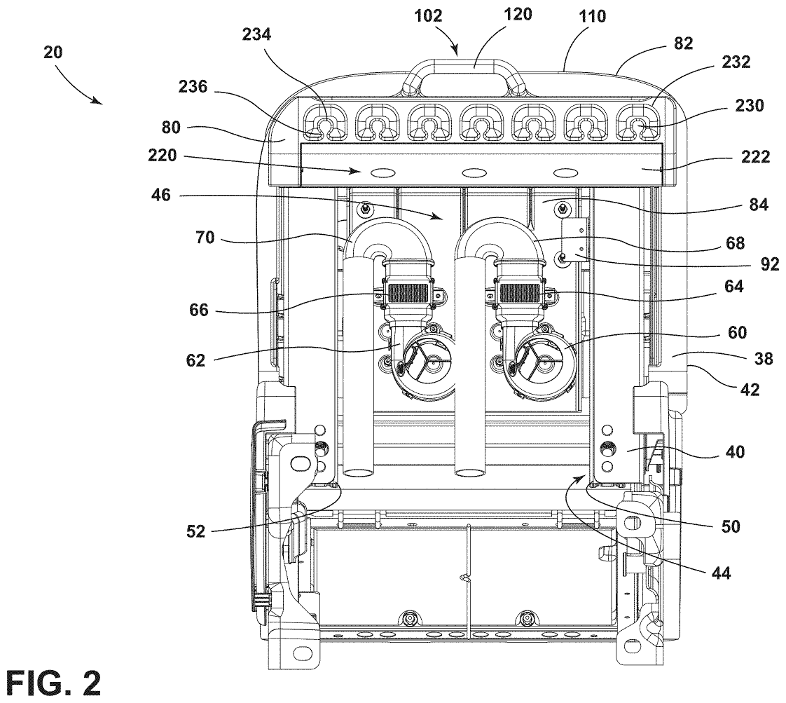

With embodiments, such as generally illustrated in FIG. 2, a seat base 22 may include a seat base frame 40, a seat cushion 42, a track assembly 44, and/or a climate assembly 46. The cushion 42 may be connected to the seat base frame 40 via the track assembly 44. For example, the seat cushion 42 may be adjustable relative to the seat base frame 40. A track assembly 44 may include a first track 50 and/or a second track 52 that may be spaced apart from each other in a lateral/Y-direction of the seat assembly 20. The first track 50 and/or the second track 52 may include respective fixed and movable tracks.

In embodiments, such as generally illustrated in FIG. 2, a climate assembly 46 may include one or more air movers 60, 62, thermoelectric devices (TEDs) 64, 66, and/or fluid conduits 68, 70. The climate assembly 46 may be configured to provide heating, cooling, and/or ventilation for the seat 20A, the seat base 22, and/or the seat back 24.

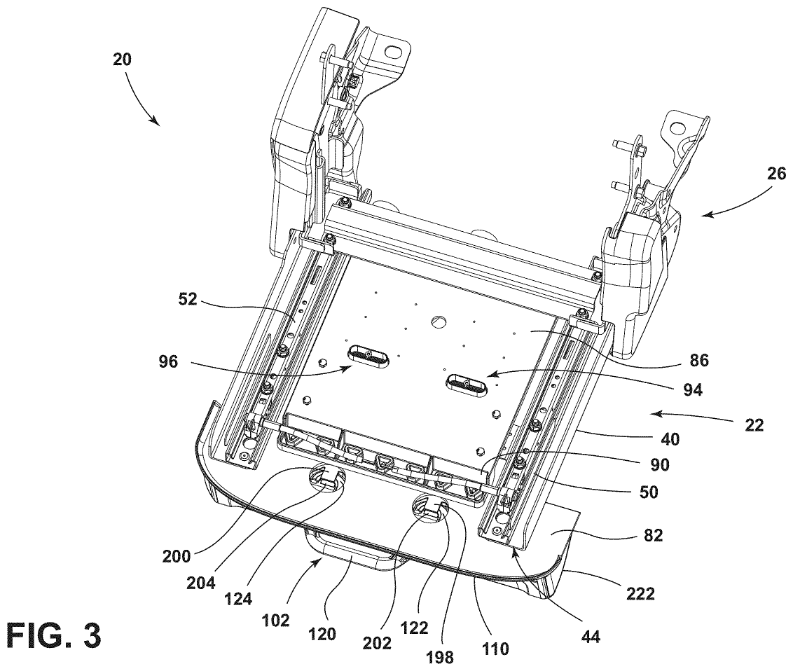

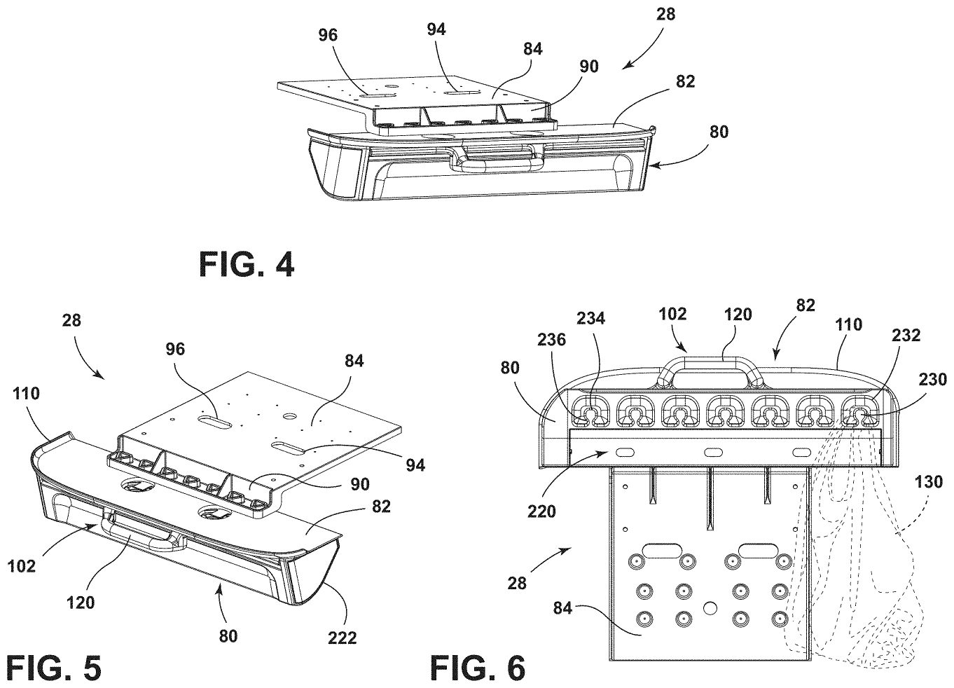

With embodiments, such as generally illustrated in FIGS. 3-6, a retractable cover assembly 28 may include a housing 80, a slide plate 82, a mounting plate 84, and/or a retractable cover 86. The housing 80 may be connected to the seat base 22 via the slide plate 82 and/or the mounting plate 84. For example and without limitation, the housing 80 may be connected and/or mounted to an underside of the seat base 22 via the mounting plate 84, which may be connected/mounted to the track assembly 44 and/or the seat base frame 40. The housing 80 may, in some configurations, be disposed at or about a front end of the seat base 22. One or more portions of the retractable cover assembly 28 may, with some configurations, extend beyond the seat base 22 in one or more directions.

In embodiments, a mounting plate 84 may include one or more shapes, sizes, configurations, and/or materials. For example, as generally illustrated in FIGS. 3-5, a mounting plate 84 may include a generally rectangular configuration with a stepped portion 90 that may be connected to the housing 80. The mounting plate 84 may extend into the seat base 22, such as at least partially between (e.g., in a lateral/Y-direction) the first track 50 and the second track 52 (see, e.g., FIG. 3). Additionally or alternatively, the mounting plate 84 may be disposed at least partially in the seat cushion 42 and/or may be disposed at least partially above a lower edge of a trim cover 38 of the seat base 22. In some configurations, the mounting plate 84 may be connected to movable portions of the first track 50 and/or the second track 52 such that the retractable cover assembly 28 may move with the movable portions and/or the seat cushion 42. In other configurations, the mounting plate 84 may be connected to the seat base frame 40 such that the housing 80 may not move relative to the seat base frame 40. For example, the mounting plate 84 may be connected to the seat base frame 40 via a bracket 92 (see, e.g., FIGS. 2 and 3). In some configurations, a mounting plate 84 may include one or more through apertures 94, 96 that may be in fluid communication with the climate assembly 46 (e.g., with air movers 60, 62), such as to provide climate-controlled fluid to the seat cushion 42 and/or an occupant/user thereof.

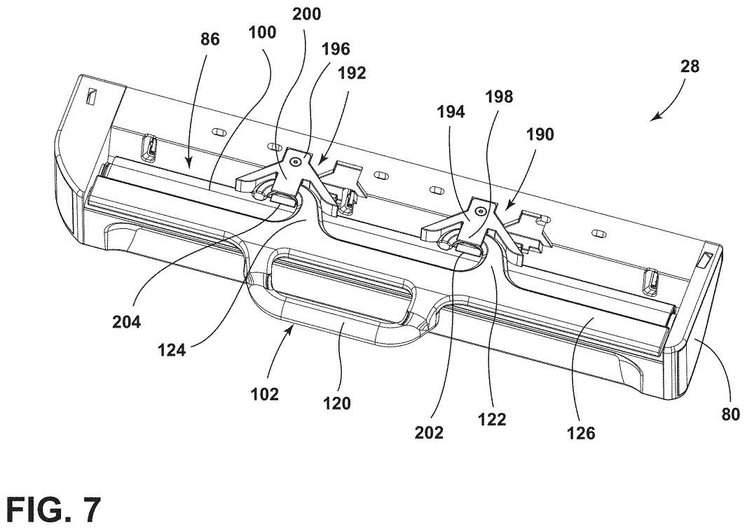

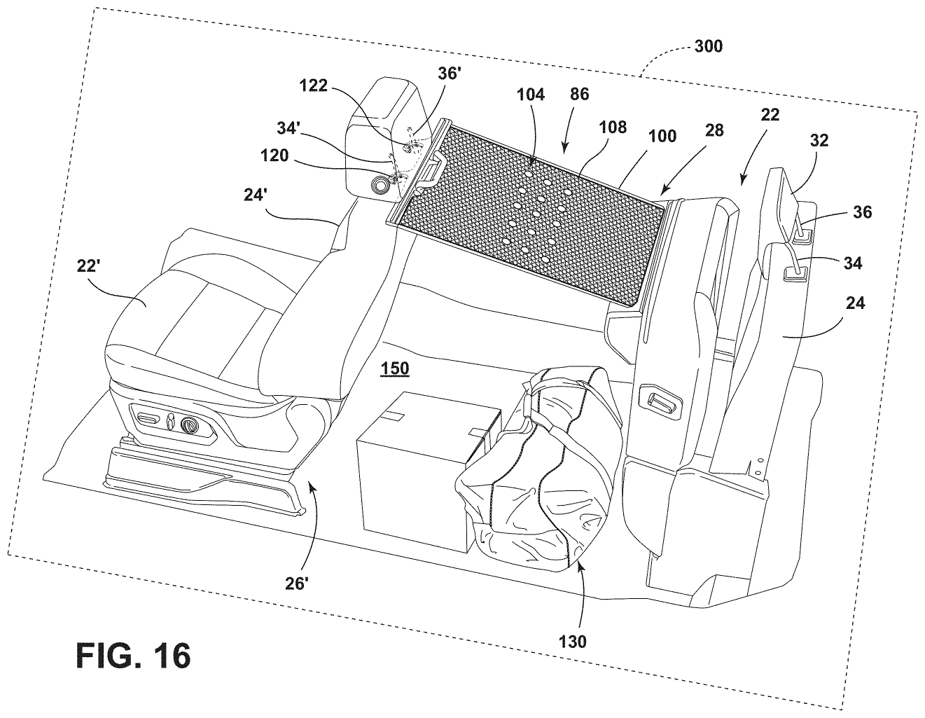

In embodiments, such as generally illustrated in FIG. 7, a retractable cover 86 may include a flexible portion/panel 100 and/or a handle 102. The flexible portion 100 may, for example and without limitation, include netting, a polymer panel, and/or a vinyl sheet, among other configurations. In some embodiments, one or more solar cells 104 may be attached to and/or integrated with the retractable cover 86. For example, a first plurality of solar cells 104 may be connected to a first side 106 of the retractable cover 86 (see, e.g., FIG. 14) and/or a second plurality of solar cells 104 may be connected to a second side 108 of the retractable cover 86 (see, e.g., FIG. 16). An example of a solar cell configuration is generally described in U.S. patent application Ser. No. 16/901,215, filed on Jun. 15, 2020, the disclosure of which is hereby incorporated by reference in its entirety as though fully set forth herein.

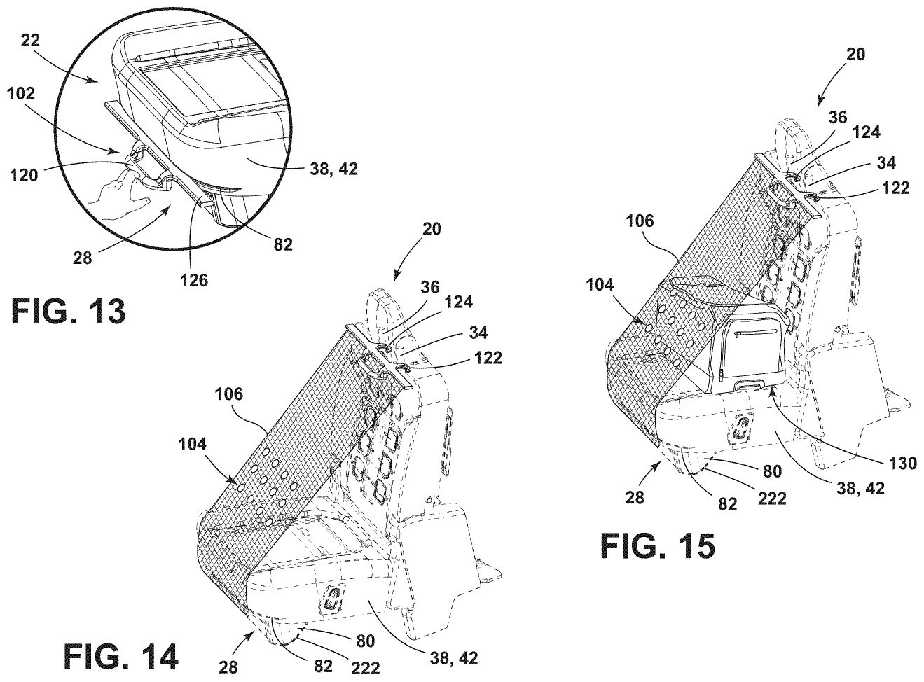

With embodiments, such as generally illustrated in FIGS. 3-6, a retractable cover assembly 28 may include a slide plate 82. The slide plate 82 may be disposed on top of the housing 80, such as at least partially between the housing 80 and the seat cushion 42. The slide plate 82 may be configured to facilitate movement of the retractable cover 86 into and/or out of the housing 80, such as when the retractable cover 86 is being moved (e.g., to or from a first engaged/hooked position). For example and without limitation, the slide plate 82 may include a tapered wall 110 that may extend upward and/or outward (e.g., forward) from the slide plate 82, and may be configured to contact the retractable cover 86 when the retractable cover 86 is being moved (e.g., to or from a first engaged position). Such contact may limit/reduce contact between the retractable cover 86 and the trim cover 38. For example, the slide plate 82 may reduce friction between the retractable cover 86 and the trim cover 38, which may reduce a force involved in moving the retractable cover 86 and/or may reduce wear of the trim cover 38 and/or the retractable cover 86. The slide plate 82 and/or the tapered wall 110 may, at least in some configurations, extend beyond portions of the housing 80, the trim cover 38 and/or the seat cushion 42. Additionally or alternatively, the slide plate 82 may press/sandwich the trim cover 38 with the seat cushion 42 and/or the seat base frame 40 (see, e.g., FIGS. 1 and 13-15). The tapered wall 110 may be rounded in some configurations.

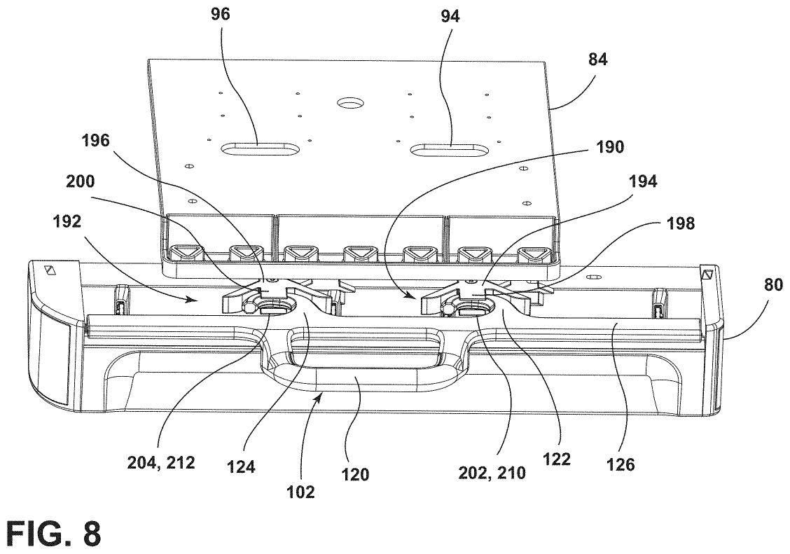

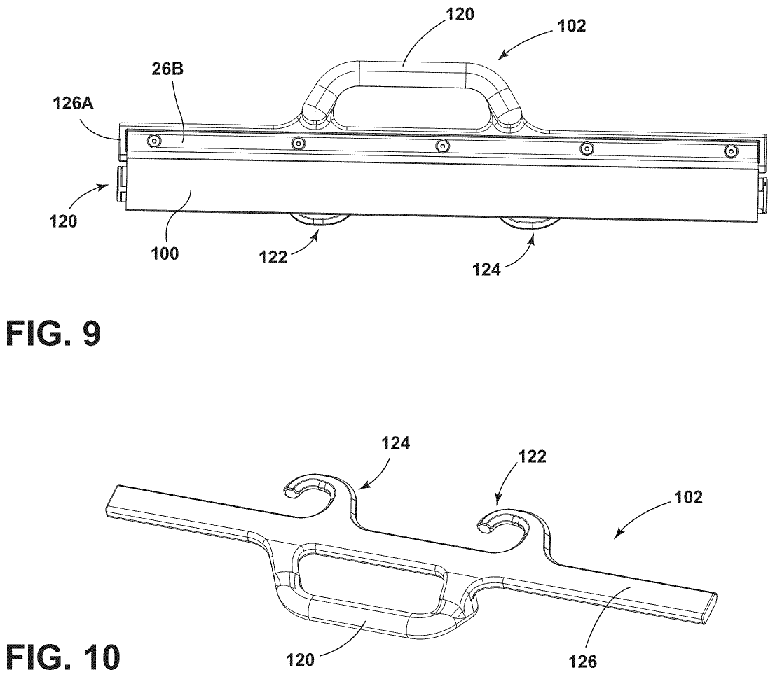

With embodiments, such as generally illustrated in FIGS. 7-10, a handle 102 may include a handle portion 120, one or more hook portions, such as a first hook portion 122 and/or a second hook portion 124, and/or a base 126. The handle portion 120 may be configured for a user to grab to move the retractable cover 86 from a retracted/stored position to one or more engaged/hooked positions. For example, the handle portion 120 may extend outward from the base 126 such that the handle portion 120 extends beyond the housing 80 and/or the seat cushion 42 (e.g., in a forward/X-direction of the seat assembly 20) (see, e.g., FIG. 2). The handle portion 120 may be rounded and/or include a generally cylindrical configuration to facilitate rotation a user's hand around the handle portion 120 and/or rotation of the handle portion 120 in the user's hand as the user moves the retractable cover 86 between retracted and engaged positions. In some examples, the handle portion 120 may include a stepped/offset configuration in which the handle portion 120 extends down from the base 126 and then outward. Such a configuration may provide additional room for the user's hand (e.g., between the handle portion 120 and the seat cushion 42) to facilitate the user manipulating the handle portion 120. The base 126 may include a first portion 126A and a second portion 126B. The first portion 126A and the second portion 126B may be fastened together such that at least a portion of the flexible portion 100 is disposed between the first portion 126A and the second portion 126B (see, e.g., FIG. 9).

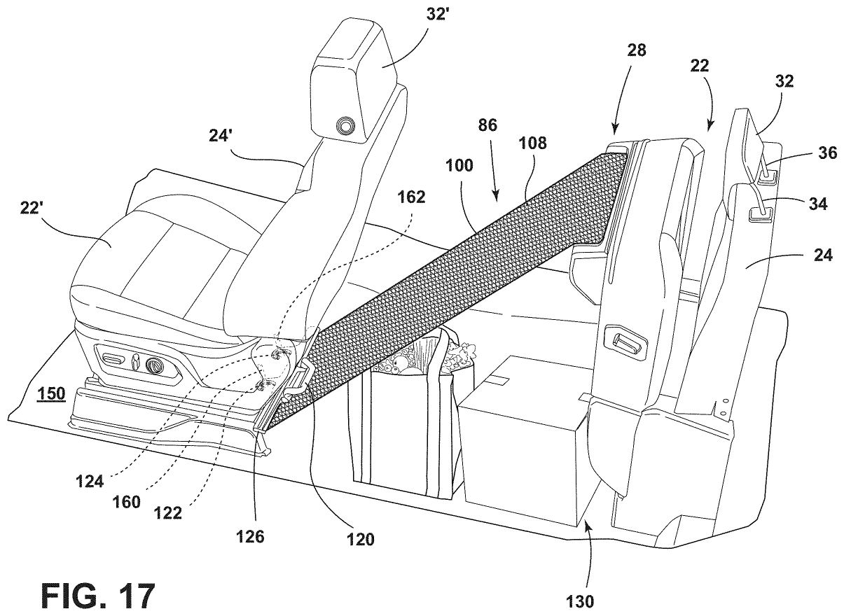

In embodiments, the one or more hook portions 122, 124 may be configured to engage one or more portions of seat assembly 20, such as portions of a seatback 24 of a first seat 20A (see, e.g., FIGS. 14, 15, 18, 22, and 23) and/or portions of a second seat 20B, such as a second seat base 22′, a second seatback 24′, and/or a second seat frame 26′ (see, e.g., FIGS. 16 and 17). For example, a retractable cover 86 may include one or more engaged/hooked positions.

In a first engaged/hooked position, the one or more hook portions 122, 124 may be engaged with portions of a seatback 24. In examples of a first configuration of a first engaged position, the hook portions 122, 124 may have an open hooked configuration and may engage (e.g., hook around) respective posts 34, 36 of a headrest 32 (see, e.g., FIGS. 14, 15, and 18).

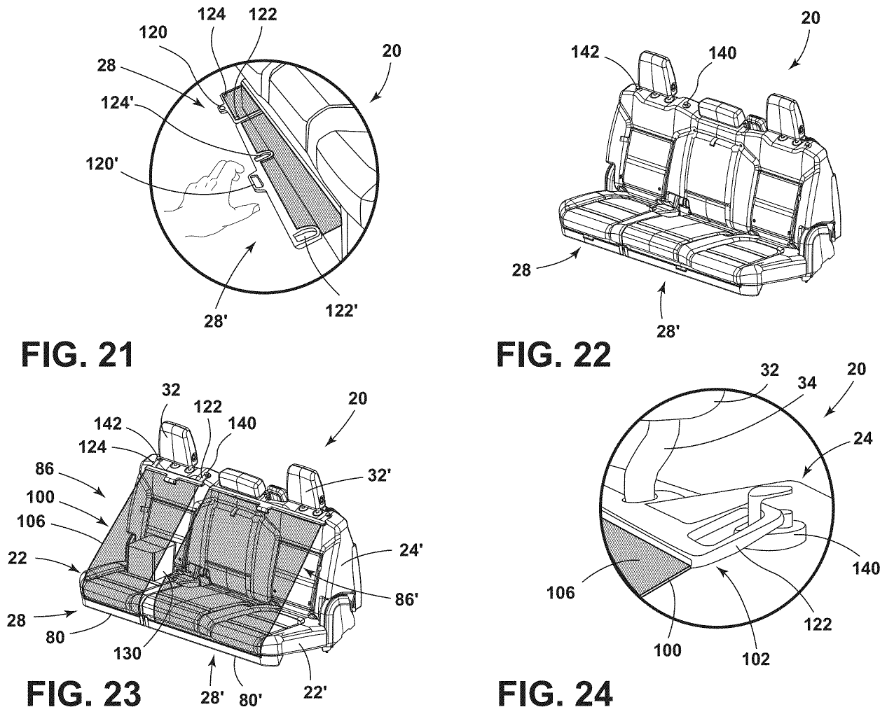

In examples of a second configuration of a first engaged position, hook portions 122, 124 of a retractable cover 86 may engage engagement features 140, 142 of the seatback 24 that may be separate from posts 34, 36 (see, e.g., FIGS. 23 and 24). For example and without limitation, hook portions 122, 124 may include a closed hook configuration that may engage the engagement features 140, 142 that may include an open hook or post configuration (see, e.g., FIGS. 21-24). The engagement features 140, 142 may be disposed at and/or in a top surface of the seatback 24.

In the first configuration and/or the second configuration of the first engaged position, the retractable cover 86 may be configured to limit movement of items/cargo 130 (e.g., groceries, suitcases, boxes, etc.) disposed on the seat base 22. For example, the retractable cover 86 may limit forward and/or upward movement of items/cargo 130 in the event of a sudden deceleration (e.g., forceful braking/slowing, vehicle crash, etc.). Additionally or alternatively, the retractable cover 86 may reduce the amount of sunlight that reaches the seat base 22 or seatback 24 (e.g., to limit UV light exposure) and/or may limit visibility of the cargo 130, such as for security purposes. In the first engaged position, the handle 102 (e.g., the handle portion 120, the hook portion(s) 122, 124, and/or the base 126) may be disposed in substantially the same orientation as when the handle 102 is in a retracted position. For example, the handle 102 may be substantially parallel to a mounting surface 150 (e.g., substantially horizontal), the hook portions 122, 124 may extend substantially rearward, and/or the handle 120 may extend substantially forward in the first engaged position and in the retracted position.

With embodiments, such as generally illustrated in FIG. 16, a retractable cover 86 may include a second engaged position. For example, the hook portions 120, 122 may engage posts 34′, 36′ associated with a headrest 32′ of a second seatback 24′ of a second seat 20B. The second seatback 24′ may be connected to a second seat base 22′ and/or a second seat frame 26′. The second seat 20B may be offset from the first seat 20A, such as in front of the first seat 20A. The seat base 22 of the first seat 20A may be disposed in a seating position or a storage position. With the second engaged position of the retractable cover 86, the retractable cover 86 may at least partially cover or shield one or items/cargo 130 that may be disposed on a mounting surface 150 (e.g., a vehicle floor for vehicle applications). In the second engaged position and with the seat base 22 in a storage position, the retractable cover 86 may, for example and without limitation, be disposed generally horizontal and/or at a small angle relative to horizontal (e.g., about 20 degrees or less).

With embodiments, such as generally illustrated in FIG. 17, a retractable cover 86 may include a third engaged position. For example, hook portions 120, 122 may engage engagement features 160, 162 of the second seat 20B. The engagement features 160, 162 may, for example, include posts, bars, hooks, and/or recesses, among others, and may connected to and/or formed with the seat base 22′, the seatback 24′, and/or the seat frame 26′. The engagement features 160, 162 may, at least in some configurations, be disposed proximate the mounting surface 150 such that the engagement features 160, 162 are disposed at least partially below a level of the bottom of the seatback 24′. With the third engaged position of the retractable cover 86, the retractable cover 86 may at least partially cover or shield one or items/cargo 130 that may be disposed on a mounting surface 150. In the third engaged position and with the seat base 22 in a storage position, the retractable cover 86 may, for example and without limitation, be disposed generally at acute angle relative to the mounting surface 150. The angle may, for example and without limitation, be about 25 degrees to about 80 degrees, and may depend on the distance between the first seat 20A and the second seat 20B.

In embodiments, the retractable cover 86 may be selectively connectable with the seatback 24 (e.g., posts 34, 36) at least when the seat base 22 is disposed in a seating position. The retractable cover 86 be selectively connectable with the seatback 24 when the seat base 22 is in a storage position, but there may be less room for cargo 130 between the retractable cover 86 and the seat base 22. The retractable cover 86 may be selectively connectable with a second seat 20B (e.g., a second seat base 22′, a second seatback 24′, and/or a second seat frame 26′) at least when the seat base 22 is in a storage position. The retractable cover 86 may be selectively connectable with the second seat 20B when the seat base 22 is in a seating position, but there may be less room for cargo 130 between the retractable cover 86 and the mounting surface 150.

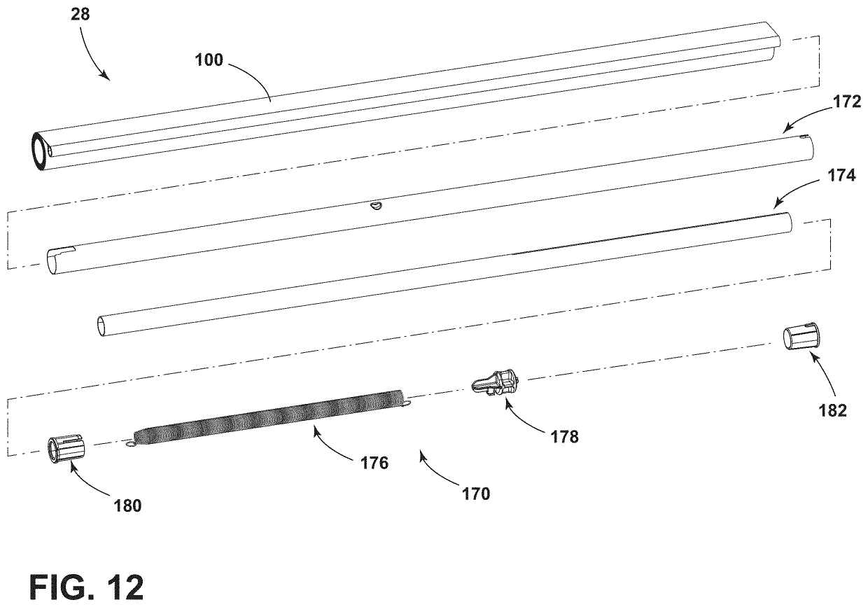

With embodiments, such as generally illustrated in FIG. 12, a retractable cover assembly 28 may include a roller 170 that may include a first tube 172, a second tube 174, a spring 176, a connector 178, a first cap 180, and/or a second cap 182. The retractable cover 86 may be connected to and/or wrapped around the first tube 172. The second tube 174 may be disposed at least partially in the first tube 172 and/or may be shorter than the first tube 172. The spring 176 may be disposed at least partially in the first tube 172 and/or the second tube 174. The spring 176 may, for example and without limitation, include a coil spring, a helical spring, and/or a torsion spring, among others. The connector 178 may be disposed at least partially the in the first tube 172 and/or the second tube 174, and/or may be connected to the spring 176. The caps 180, 182 may be connected to and/or inserted into respective ends of the first tube 172. The roller 170 may be configured to bias the retractable cover 86 toward a retracted position. For example, the spring 176 may act on (e.g., apply a rotational biasing force to) the connector 178, which may act on the first tube 172. The second tube 174 may be substantially fixed, such as relative to the housing 80, and the first tube 172 may rotate with the retractable cover 86 about the second tube 174 as the retractable cover 86 moves toward and away from a retracted position.

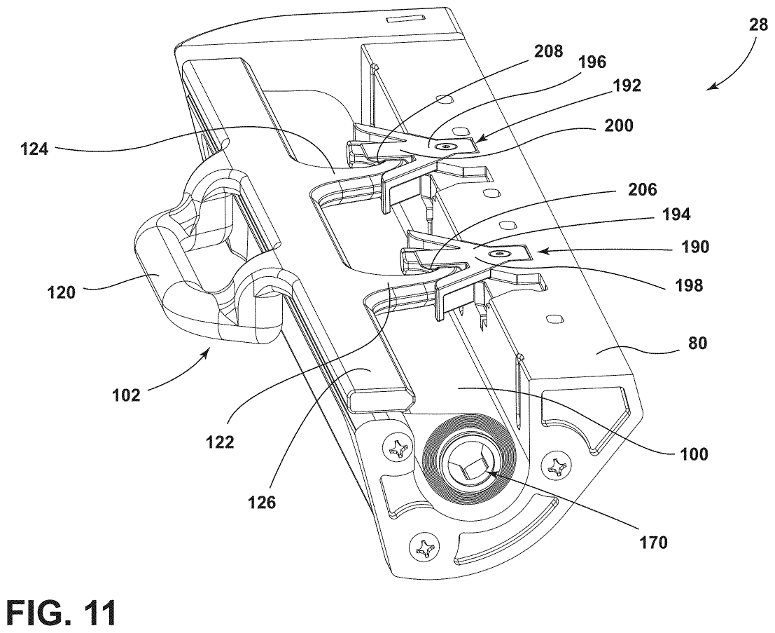

In embodiments, such as generally illustrated in FIGS. 7, 8, and 11, a housing 80 may include one or more receptacles, such as a first receptacle 190 and/or a second receptacle 192. The receptacles 190, 192 may be configured to at least partially receive corresponding portions of a handle 102, such as hook portions 122, 124, when the handle 102 is in a retracted position. A receptacle 190, 192 may include a body 194, 196, a first arm 198, 200, and/or a second arm 202, 204. The body 194, 196 may include a generally U-shaped configuration that may correspond to and/or at least partially receive a hook portion 122, 124. For example, in a retracted position of the retractable cover 86, the body 194, 196 may be in contact with opposite lateral sides of the hook portions 122, 124. With a U-shaped configuration, the body 194, 196 may open generally forward in an X-direction. The body 194, 196 may be relatively rigid and may not be configured to flex or deflect to a significant degree via contact with a hook portion 122, 124.

With embodiments, a first arm 198, 200 and/or a second arm 202, 204 may extend substantially forward in an X-direction and may be aligned with a middle of the body 194, 196. The first arm 198, 200 and the second arm 202, 204 may be disposed in an opposing configuration (e.g., offset in a vertical/Z-direction) and/or may be configured to deflect in opposite vertical/Z-directions when contacted by the hook portions 122, 124, such as when the hook portions 122, 124 are inserted into and removed from the receptacles 190, 192. A first arm 198, 200 may include a first protrusion 206, 208 that may extend from a distal end toward the second arm 202, 204 (e.g., downward). A second arm 202, 204 may include a second protrusion 210, 212 that may extend from a distal end toward the first arm 198, 200 (e.g., upward). For example and without limitation, the arms 198-204 may be configured as opposing latches. The arms 198-204 and the protrusions 206-212 may be configured to provide tactile feedback to a user when the hook portions 122, 124 are properly disposed in the receptacles 190, 192. The arms 198-204 and the protrusions 206-212 may be configured such that the hook portions 122, 124 can be inserted into the receptacles 190, 192 without independent actuation of the arms 198-204 or the protrusions 206-212. For example, a user may pull on the handle 102 to remove the hook portions 122, 124 from and insert the hook portions 122, 124 into the receptacles 190, 192 without the user separately disengaging the arms 198-204 or the protrusions 206-212.

In embodiments, the receptacles 190, 192 may be configured to restrict movement of the hook portions 122, 124 when the retractable cover 86 is in a retracted position. For example and without limitation, the body 194, 196 may be configured to restrict and/or prevent lateral/Y-direction movement and rearward/X-direction movement, the arms 198-204 may be configured to restrict and/or prevent vertical/Z-direction movement, and/or the protrusions 206-212 may be configured to restrict forward/X-direction movement. The receptacles 190, 192 may be configured to maintain the handle 102 in a generally horizontal configuration while the retractable cover 86 is in a retracted position (e.g., maintain a consistent retracted position). Additionally or alternatively, the receptacles 190, 192 may be configured to limit noise/rattling caused by the retractable cover 86.

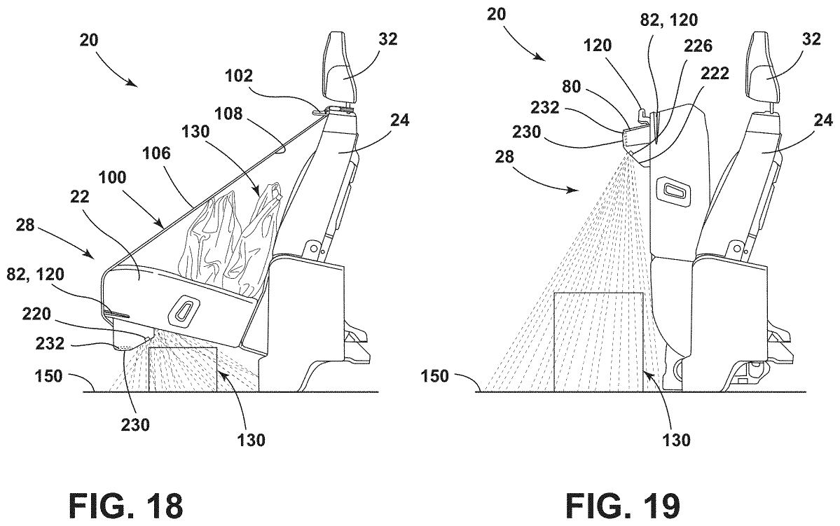

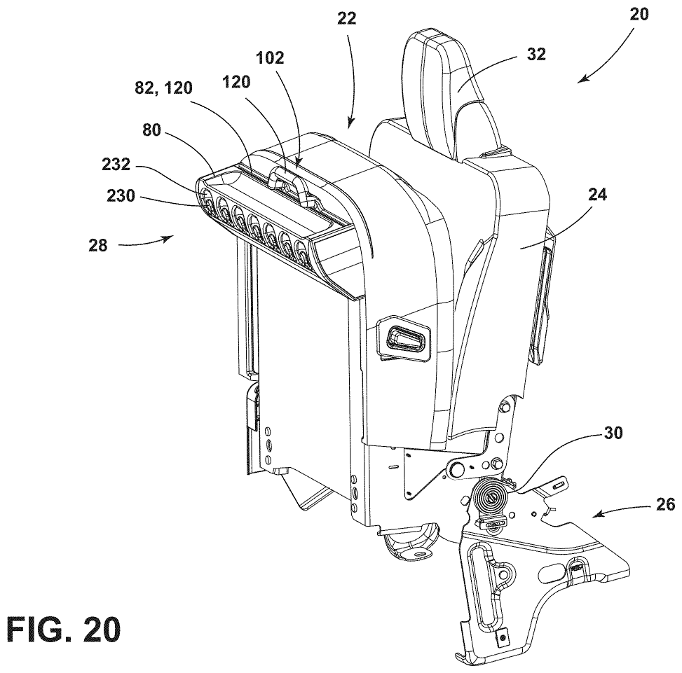

With embodiments, such as generally illustrated in FIGS. 18 and 19, a retractable cover assembly 28 may include one or more lights 220. The one or more lights 220 may be connected to and/or disposed at least partially in the housing 80. For example, the one or more lights 220 may be connected to and/or disposed at least partially in a tapered wall 222 of the housing 80 such that the lights 220 are configured to illuminate at least some of the same portions of the mounting surface 150 when the seat base 22 is in a seating position (FIG. 18) and when the seat base 22 is in a storage position (FIG. 19). The one or more lights 220 may include a dedicated power source (e.g., batteries), may be connected to a system power source (e.g., a vehicle battery for vehicle applications), and/or may be powered, at least in part, via one or more solar cells 104.

With embodiments, such as generally illustrated in FIGS. 2, 6, 18, and 19, a retractable cover assembly 28 may include one or more hooks 230 (e.g., cargo hooks). The one or more hooks 230 may be connected to, formed with, and/or disposed at least partially in the housing 80. For example, the hooks 230 may include protrusions disposed in respective recesses 232 of the housing 80. In some configurations, when the seat base 22 is in a seating position (FIG. 18), the hooks 230 may extend generally in an X-direction (e.g., forward), and/or when the seat base 22 is in a storage position (FIG. 19), the hooks 230 may extend generally in a Z-direction (e.g., upward). For example, the one or more hooks 230 and/or recesses 232 may be disposed at a bottom surface of the housing 80 such that they are disposed opposite the mounting surface 150 when the seat base 22 is in a seating position. A hook 230 may include a generally round/rounded head 234 that may extend from a thinner neck 236 (see, e.g., FIG. 6).

With embodiments, such as generally illustrated in FIGS. 21-23, a seat assembly 20 may include a bench configuration with a first seat base 22 and seatback 24 and a second seat base 22′ and seatback 24′ that may be disposed adjacent (e.g., in a lateral/Y-direction) to the first seat base 22 and seatback 24. A first retractable cover assembly 28 may be connected to the first seat base 22. A second retractable cover assembly 28′ may be connected to the second seat base 22′. The second retractable cover 28′ may be configured in the same or similar manner as the first retractable cover assembly 28. For example, the second retractable cover assembly 28′ may include a housing 80′ and/or a retractable cover 86′ that may have one or more engaged positions. In some configurations, the second seat base 22′ and seatback 24′ may be wider than the first seat base 22 and seatback 24′. For example and without limitation, the seat base 22′ and seatback 24′ may be configured as a larger portion of a split bench (e.g., the 60 portion of a 40/60 bench). The second retractable cover assembly 28′ may be wider than the retractable cover assembly 28 to cover the wider seat base 22′ and/or seatback 24′.

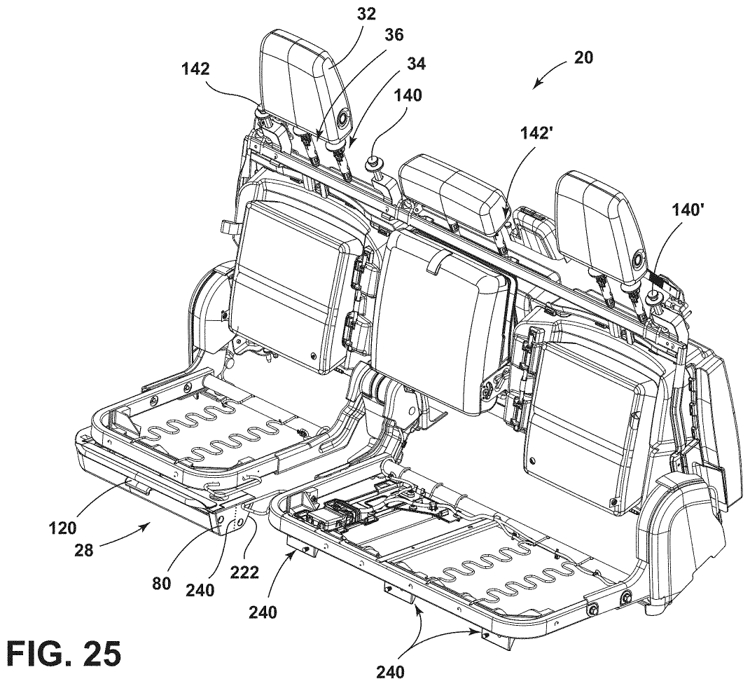

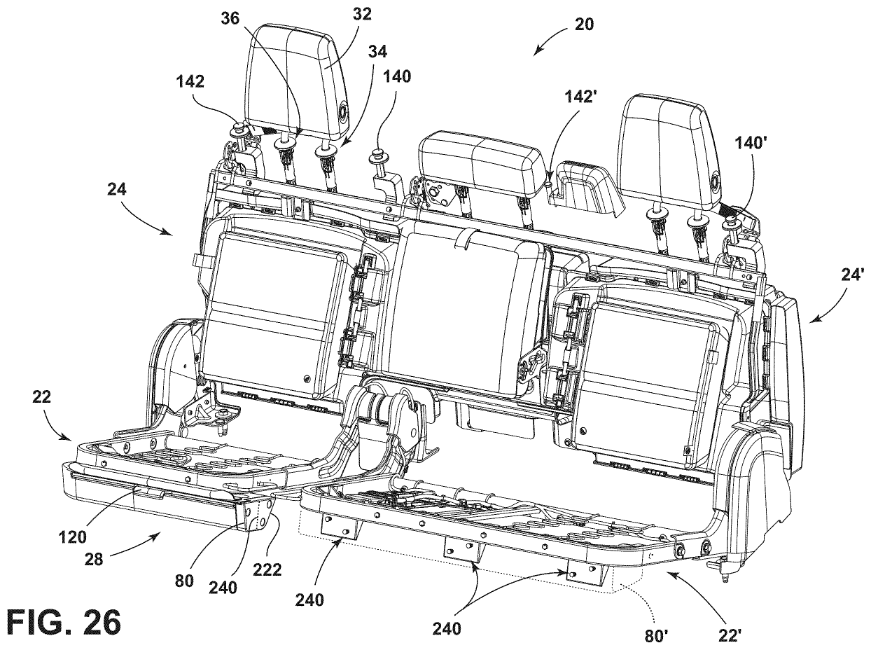

With embodiments, such as generally illustrated in FIGS. 25 and 26, a retractable cover assembly 28 may be connected to a seat base 22, 22′ via one or more mounting brackets 240, such as instead of or in addition to a mounting plate 84. The one or more mounting brackets 240 may extend general downward from a front end of the seat base 22, 22′, such as into the housing 80, 80′. The one or more mounting brackets 240 may include a tapered configuration that may correspond to a tapered wall 222 of a housing 80, 80′. For example, the one or more mounting brackets 240 may be connected to and/or in contact with an inner surface of the tapered wall 222.

In some configurations, a seat assembly 20 may be connected to and/or disposed in a vehicle 300 (see, e.g., FIG. 16), but embodiments of seat assemblies 20 are not limited to vehicle applications.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, ” “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples,” “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A seat assembly, comprising:
a seatback;
a seat base; and
a retractable cover assembly connected to the seat base;
wherein the retractable cover assembly includes a retractable cover that is selectively connectable to the seatback.

2. The seat assembly of claim 1, wherein the retractable cover assembly includes a housing mounted to an underside of the seat base.

3. The seat assembly of claim 2, wherein the seat base is configured to rotate relative to the seatback between a seating position and a storage position.

4. The seat assembly of claim 3, wherein the retractable cover is selectively connectable to the seatback at least when the seat base is in the seating position; and
the retractable cover is selectively connectable to a second seatback of a second seat at least when the seat base is in the storage position.

5. The seat assembly of claim 3, wherein the housing includes a plurality of hooks that extend generally upward when the seat base is in the storage position.

6. The seat assembly of claim 2, wherein the housing includes a tapered surface and one or more lights connected to the tapered surface.

7. The seat assembly of claim 2, wherein the retractable cover includes a plurality of solar cells disposed at a first side of the retractable cover.

8. The seat assembly of claim 7, wherein the retractable cover includes a second plurality of solar cells disposed at a second side of the retractable cover.

9. The seat assembly of claim 2, wherein the retractable cover includes a hook portion configured to releasably engage a portion of the seatback; and
the housing includes a receptacle configured to releasably engage the hook portion.

10. The seat assembly of claim 9, wherein the receptable includes deflectable first and second arms.

11. The seat assembly of claim 10, wherein the receptacle includes a U-shaped recess configured to at least partially receive the hook portion and restrict lateral movement of the hook portion; and
the first and second arms are configured to restrict longitudinal movement and vertical movement of the hook portion.

12. The seat assembly of claim 10, wherein the first and second arms are configured to provide a tactile indication that the retractable cover is in a retracted position.

13. The seat assembly of claim 2, wherein the retractable cover assembly includes a mounting plate connected to the housing that connects the housing to the underside of the seat base.

14. The seat assembly of claim 13, wherein the seat base includes a first track and a second track configured to facilitate sliding movement of a cushion of the seat base; and
the mounting plate is disposed at least partially between the first track and the second track.

15. The seat assembly of claim 2, wherein the retractable cover assembly includes a slide plate connected the housing and disposed at least partially between the housing and the seat base.

16. The seat assembly of claim 15, wherein the slide plate is in contact with a trim cover of the seat base and is configured to facilitate movement of the retractable cover relative to the trim cover.

17. The seat assembly of claim 16, wherein the slide plate includes a tapered and rounded wall that extends forward beyond the housing.

18. The seat assembly of claim 1, wherein retractable cover includes a hook portion and a handle portion;
the hook portion and the handle portion extend in opposite directions.

19. The seat assembly of claim 18, wherein the retractable cover includes a retracted position and a hooked position in which the hook portion is engaged with the seatback; and
the hook portion and the handle are in substantially the same orientation in the retracted position and the hooked position of the retractable cover.

20. The seat assembly of claim 19, wherein the seatback includes a head rest connected to a post; and
the hook portion is engaged with the post in the hooked position.
